(19) United States
(12) Patent Application Publication
(10) Pub. No.: US 2004/0012811 A1
(43) Pub. Date: Jan. 22, 2004

(54) System and method for taking, storing and printing digital pictures

(75) Inventor: Fumiharu Nakayama, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/199,084

(22) Filed: Jul. 22, 2002

(51) Int. Cl. G06F 15/00; G06F 13/00; H04N 1/387; G06K 15/02; H04N 1/393

(52) U.S. Cl. 358/1.15; 455/556.1; 345/725; 358/1.18; 358/450; 358/1.2; 358/403

(57) ABSTRACT

A system and method for storing images includes receiving an e-mail with one or more attached images from a cellular telephone, generating an identification number corresponding to the received one or more images, and storing the received one or more images in a memory. A message is received from a kiosk including the identification number. The one or more images are sent to the kiosk based on the received identification number.

### FIELD OF THE INVENTION

The present invention relates generally to image processing, and more particularly to a system and method for taking, storing and printing digital pictures.

### BACKGROUND OF THE INVENTION

Digital cameras enable users to take pictures and store the images of those pictures in a memory. The number of pictures that can be stored in the memory depends upon the size of the memory and the resolution at which the pictures are taken, although the number is typically much more than the number in a standard roll of film in an analog camera.

To print out the pictures, the user of the digital camera transfers the contents of the memory of the digital camera to the user's personal computer. The personal computer has software with which the user can view and edit the digital pictures. In addition, the user can select which of the digital pictures to print. When traveling or away from home, however, the user is much more limited in their ability to view, edit and printing of pictures. In particular, the user is unable to use their personal computer to do these functions until they return home.

### SUMMARY OF THE INVENTION

Briefly, in one aspect of the invention, a method for storing images includes receiving an e-mail with one or more attached images from a cellular telephone, generating an identification number corresponding to the received one or more images, and storing the received one or more images in a memory. A message is received from a kiosk including the identification number. The one or more images are sent to the kiosk based on the received identification number.

In another aspect of the present invention, image size information is received from the kiosk, and the one or more images are converted based on the image size information.

### BRIEF DESCRIPTION OF THE DRAWINGS

FIG. 1 is a block diagram of a image processing communication system consistent with the present invention.

FIG. 2 is a flow diagram of a digital image registration process consistent with the present invention.

FIG. 3 is a flow diagram of a digital image printing process consistent with the present invention.

FIG. 4 is a flow diagram of a digital image editing process consistent with the present invention.

FIGS. 5A and 5B are views of alternative image-UP representations for the digital image editing process of FIG. 4.

### DETAILED DESCRIPTION OF THE PREFERRED EMBODIMENT

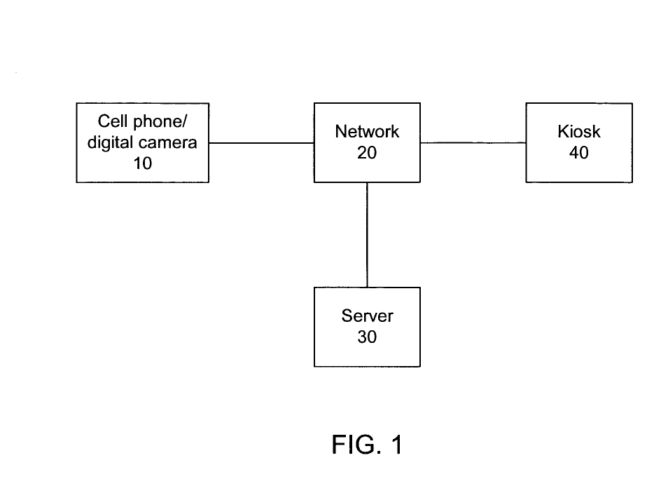

FIG. 1 is a block diagram of a communication system consistent with the present invention. As shown in FIG. 1, the communication system includes one or more phone/cameras 10, a network 20, one or more servers 30 and one or more kiosks 40. Each of the phone/cameras 10, servers 30 and kiosks 40 are coupled to the network 20. The network 20 may be implemented as a local network, such as a LAN, or as a public network, such as the Internet, PSTN, wireless or cellular network.

The phone/camera 10 is a combination of a digital camera and a cellular telephone. The camera and phone are preferably an integrated device, such as the Toshiba J-T51, which is a cellular telephone having a small camera on its back with which a user can take a picture. The phone/camera 10, when integrated, enables the integrated device to perform the functions of both a cellular telephone and a digital camera. It should be understood, however, that the phone/camera 10 may be separate devices, i.e. a separate cellular telephone and digital camera. When the phone/camera 10 includes separate devices, the cellular telephone is capable of receiving and storing image data from the digital camera.

The phone/camera 10 may have a CPU, a main memory, a ROM, a storage device and a communication interface all coupled together via a bus. The phone/camera 10 is capable of communicating with the network 20 via cellular communication and establishing an Internet connection. The Internet connection may be established by the combination of the cellular network service provider and an Internet service provider (ISP). By virtue of the communication with the network 20, the phone/camera 10 can send and receive data with the server 30, as well as other devices coupled to the network 20.

The server 30 includes a CPU, a main memory, a ROM, a storage device and a communication interface all coupled together via a bus in one embodiment consistent with the present invention. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the server 30 provides a two-way data communication coupling via a network link to the network 20. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 20.

The kiosk 40 may be implemented as a personal computer or other similar computing device. Like the server 30, the kiosk 40 includes a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the kiosk 40 provides a two-way data communication coupling via a network link to the network 20. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 20.

The kiosk 40 may be located in a variety of locations. For example, the kiosk 40 may be placed in an electronics store, a supermarket, a train station, an airport, a hotel, an amusement park, a pharmacy or any other locations where members of the public can access the kiosk 40. As described below, a user can use the kiosk 40 to view, edit and print digital images taken by the phone/camera 10.

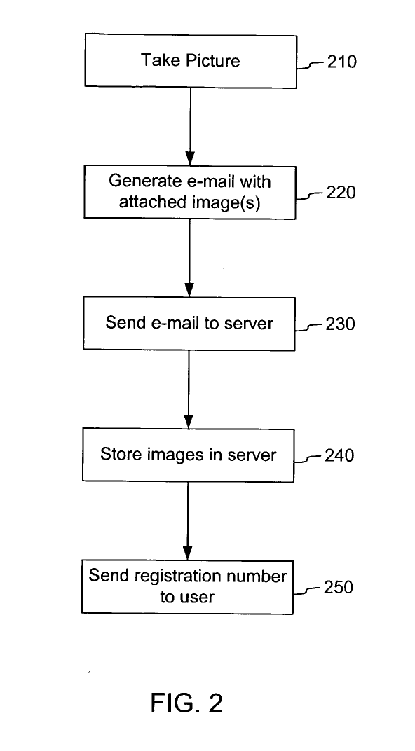

FIG. 2 is a flow diagram of a digital image registration process consistent with the present invention. As shown in FIG. 2, the user first takes a picture with the phone/camera 10 (step 210). If the phone/camera 10 is an integrated device, then the phone/camera 10 includes functionality to enable the user to take pictures with the integrated device. When they are separate, the user takes the picture with the separate digital camera. The picture taken by the phone/camera 10 is stored in a memory in the phone/camera 10. The user can access the digital image corresponding to the picture stored in the memory, such as to view the image.

After taking one or more pictures, the user can generate an e-mail with one or more the digital images for the pictures as attachments (step 220). As described above, the phone/camera 10 is capable of establishing an Internet connection by which the user can send the e-mail. The phone/camera 10 may include software that enables the user to compose the e-mail and attach one or more images to the e-mail. If the digital camera is not integrated with the cellular telephone, the user can first transfer the images to the cellular telephone with a communication link, such as a USB serial connection, although other communication protocols may be used. The images are stored in the memory of the cellular telephone. With the images stored in the memory of the cellular telephone, the user can compose the e-mail and attach the images received from the digital camera.

The e-mail generated by the user with the phone/camera 10 is sent to the server 30 (step 230). The phone/camera 10 may include the address of the server 30 such that the user need not enter the address manually. For example, the address of the server 30 may be located in an address book that the user selects. If there is more than one server 30 capable of receiving the e-mail, the phone/camera 10 may have a list of servers 30 to which to send the e-mail. Alternatively, the e-mail may be sent to a central address, which distributes it to one of the servers 30 based on some criteria, such as location or volume. In addition to the address of the server 30, the e-mail may include an identifier indicating that the e-mail includes the attached images and that the attached images are for the registration process.

The server 30 receives the e-mail sent by the phone/camera 10 and stores the images attached to the e-mail (step 240). The server 30 is configured to recognize that the e-mail received from the phone/camera 10 is intended for the registration process. This recognition may be as a result of all e-mails received by the server being intended for the registration process. Alternatively, as described above, the e-mail may include an identifier recognized by the server 30 as indicating that the e-mail is intended for the registration process. The server 30 may also recognize the e-mail as being intended for the registration process when the e-mail includes images as attachments.

The server 30 extracts the attached images from the e-mail and stores them in a storage or memory of the server 30. The server 30 stores the image in the memory in a manner that enables the server 30 to later identify which images corresponded to the particular e-mail. To facilitate this identification, the server 30 can generate an identification or registration number for each e-mail received or for each image in the email. For example, if the received e-mail includes four images, the server 30 can generate a single registration number for the e-mail that corresponds to each of the four images, or can generate a registration number for each of the four images. The images can be stored in the memory of the server 30 with a link to the corresponding registration number, so that the images can be identified at a later time by referencing the registration number.

Alternatively, the user of the registration process may previously arrange for the server 30 to store the images from that user in a predetermined area, such as a folder with the user's name or a unique identifier. The images stored in the memory of the server 30 may include a description identifying the time the image was received, the name of the image in the e-mail, and some identifier, such as the registration number generated for the image, as well as any other information that may be used to identify the image.

In addition to generating the registration numbers for the received images, the server 30 sends the one or more registration numbers to the user who send the e-mail (step 250). The server 30 can send the registration number to the user with an e-mail sent to the phone/camera 10 of the user. The registration number received by the user enables the user to reference and locate the images previously sent to the server 30 by the user's phone/camera 10.

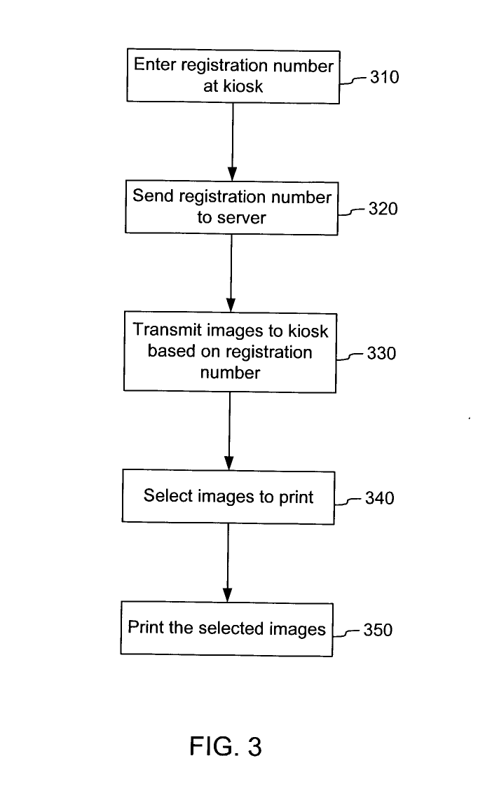

FIG. 3 is a flow diagram of a digital image printing process consistent with the present invention. As shown in FIG. 3, the user enters the registration number at a kiosk (step 310). As described above, the kiosk 40 may be implemented as a personal computer or other similar computing device having a communication interface to provide a two-way data communication coupling via a network link to the network 20. To enter the registration number, the user may use an input device such as a keyboard. The kiosk 40 may be located in a variety of locations. For example, the kiosk 40 may be placed in an electronics store, a supermarket, a train station, an airport, a hotel, an amusement park, a pharmacy or any other locations where members of the public can access the kiosk 40. With the placement of kiosks 40 in a variety of locations, a user can use a kiosk 40 to access the images stored in the server 30, even when the user is unable to use their own personal computer at home.

The registration number entered by the user is sent to the server 30 (step 320). The registration number may be sent in an e-mail or in some other message protocol that may be received by the server 30. The server 30 receives the message from the kiosk 40 and identifies the registration number. The server 30 also identifies the kiosk 40 from which the message was sent, as well as characteristics of the kiosk 40, such as the printing and viewing capabilities of the kiosk 40.

Using the identified registration number, the server 30 locates the image or images associated with the registration number. As described above, the images can be stored in the memory of the server 30 with a link to the corresponding registration number. The server 30 than transmits the located image or images to the kiosk 40 (step 330). The server 30 can transmit the images in the same message format in which the registration number was received from the kiosk 40. For example, if the registration number message was sent as an e-mail, the server 30 can send the images to the kiosk 40 as an e-mail with the image or images included as attachments.

The images sent by the server 30 in the message are received by kiosk 40. The kiosk 40 extracts the images from the message and displays them to the user at the kiosk 40. The images may be displayed on a monitor or screen of the kiosk 40, such as a CRT monitor or LCD screen. As will be described in more detail below, the images can be displayed to the user in a variety of sizes and resolutions. The user can also select which and how many images are being displayed.

With the one or more images displayed to the user at the kiosk 40, the user selects which images to print (step 340). The user can make the selection with an input device, such as a keyboard entry or with the click of a pointing device. The user can select to print each image on a single page or multiple images on the same page. The user can also select the orientation, paper size, and paper source, as well as other settings or parameters. To facilitate the various selections, the kiosk 40 may display a window or interface which prompts the user to indicate how to print the images, including the entry of any desired settings or parameters.

The kiosk 40 then prints the images selected by the user (step 350). The kiosk 40 may include a variety of paper types of varying quality on which to print the images. The user may be charged appropriately based on the number of images printed and the quality of the paper used. The paper may also include stickers, where each sticker includes its own image.

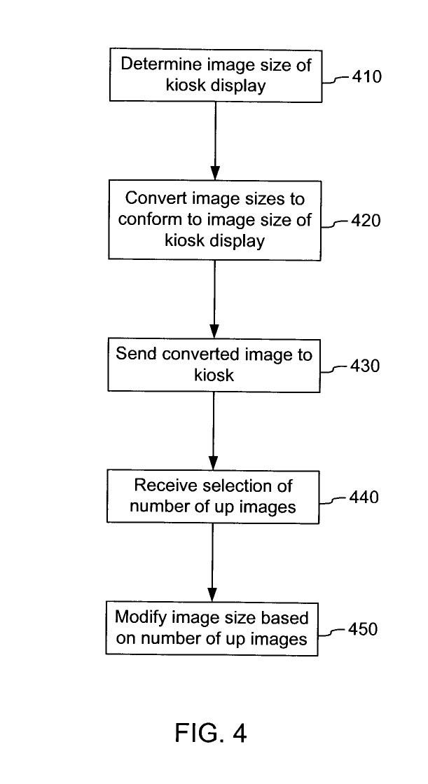

FIG. 4 is a flow diagram of a digital image editing process consistent with the present invention. As described above, the server 30 receives a message from the user at the kiosk 40 where the message identifies the registration number, an identification of the kiosk 40 from which the message was sent, as well as characteristics of the kiosk 40, such as the printing and viewing capabilities of the kiosk 40. Using the information in the message, the server 30 determines the image size of the display of the kiosk 40 (step 410). The image size information for the display of the kiosk 40 may include the physical dimensions of the display, as well as the resolution for the display. For example, the display may be a 15 inch screen having a resolution of 1024×768 pixels.

After identifying the applicable images according to the message received from the kiosk 40, the server 30 converts the sizes of the identified images to conform to the display of the kiosk 40 (step 420). The images received in the e-mail from the phone/camera 10 of the user have size and resolution settings. Information regarding the size and resolution settings of the images, the size and resolution settings of the display of the kiosk 40, and the number of images to be displayed simultaneously are used to convert the size and resolution of the images. For example, the number of images to be displayed and the size of the display of the kiosk 40 affects the size of each image displayed. In addition, if the resolution of the display of the kiosk 40 is lower than the resolution of the image, the resolution for the image may also be adjusted.

The converted images are then sent to the kiosk 40 (step 430). The converted images are received by the kiosk 40 and displayed to the user on the display of the kiosk 40. There may be one or more images shown in the display. The images shown are preferably sized to maximize the amount of space used in the display of the kiosk 40. As a default, when the images are first sent to the kiosk 40, only one image may be shown or all of the images may be shown initially.

Based on the images being shown, the user selects the number of UP images, and the server 30 receives the selection (step 440). The number of UP images corresponds to the number of images being shown at the same time. For example, the user can select to have 1, 4, 8, 16 or other number of images to be shown at the same time. Each of the UP images may be different from each of the other UP images or may all be the same. For example, if the user had eight images stored in the server 30, the user may elect to have each of the eight images shown to see how each one looks. The user may also elect to have one shown by itself to see it in as a larger image. In addition, the user may elect to have a single image shown as an 8-UP image, which are then printed, so that 8 pocket size images of the single image can be printed on the same page.

In response to the selection of the number of UP images, the server 30 modifies the image size (step 450). As described above, the number of UP images and the size of the display affects the size of the image that can be shown in the display of the kiosk 40. The server 30 can also change which of the images are to be shown in the display of the kiosk 40 in response to an indication received from the user at the kiosk 40.

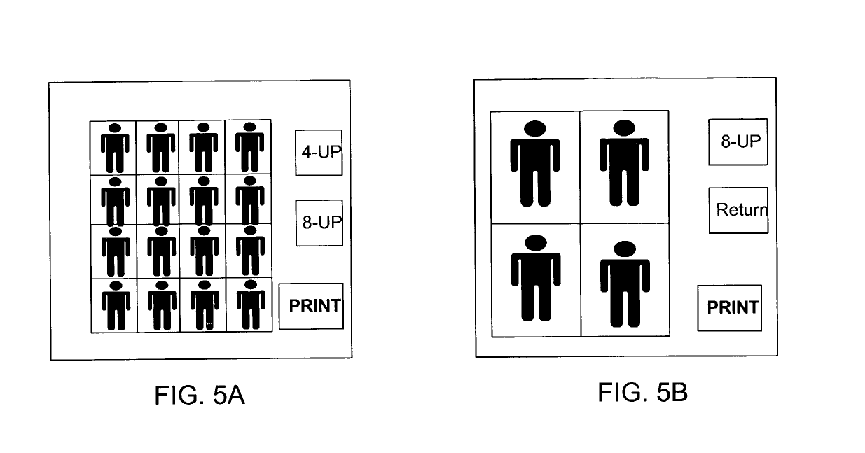

FIGS. 5A and 5B are views of alternative image-UP representations for the digital image editing process of FIG. 4. In FIG. 5A, a 16-UP image representation is shown. Each of the images shown in this representation is the same. However, as described above, each of the images may be different. As shown in the display in FIG. 5A, the user may select to change the number of UP images to 4 or 8, as well as to print the images shown. It should be understood, however, that the number of UP images may be of different values, or the user can select any value between one and some predetermine maximum number.

FIG. 5B shows a 4-UP image representation. This representation can be selected by the user by selecting the 4-UP icon or box shown in FIG. 5A. As shown in FIG. 5B, with fewer UP images shown, the size of each image can be increased as compared to the images shown in the 16-UP representation of FIG. 5A.

As described above, the user submits the images to the server 30 from their phone/camera 10, receives a registration number from the server, and then accesses the images at the kiosk 40 by entering the registration number. It is possible to arrange for the submission of the images from the phone/camera 10 to the server 30 and to later access them at the kiosk 40 without the registration number. For example, the user can arrange to have a username and password to access the server 30 from the kiosk 40. To access the images, they can be transmitted from the phone/camera 10 to a storage area in the server 30 corresponding to that user's username. The username and password may be set up prior to the first time the user transmits the images to the server 30. Each time the user transmits images to the server 30, the images may all be stored in a single folder. It is also possible that each time images are transmitted, they are stored in sub-folders of a main folder corresponding to that username. Each sub-folder may have a name designated by the user or correspond to the time and/or date they were received by the server 30.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for storing images, comprising:
receiving an e-mail with one or more attached images from a cellular telephone;
generating an identification number corresponding to the received one of more images;
storing the received one or more images in a memory;
receiving a message from a kiosk including the identification number; and
sending the one or more images to the kiosk based on the received identification number.

2. A method according to claim 1, further comprising receiving image size information from the kiosk.

3. A method according to claim 2, further comprising converting the one or more images based on the image size information.

4. A method according to claim 1, wherein the cellular telephone includes a digital camera with which the images attached in the e-mail are formed.

5. A method according to claim 1, wherein the kiosk includes a personal computer connected to the server via a network connection.

6. A method according to claim 5, wherein the kiosk includes a display through which the images sent to the kiosk can be viewed.

7. A method according to claim 1, further comprising sending a message to the cellular telephone including the identification number.

8. A method according to claim 1, wherein the message sent to the cellular telephone includes an acknowledgment that the e-mail has been received.

9. A computer readable medium operable on a computer system for storing images, the computer readable medium configured to:
receive an e-mail with one or more attached images from a cellular telephone;
generate an identification number corresponding to the received one or more images;
store the received one or more images in a memory;
receive a message from a kiosk including the identification number; and
send the one or more images to the kiosk based on the received identification number.

10. A computer readable medium according to claim 9, further configured to receive image size information from the kiosk.

11. A computer readable medium according to claim 10, further configured to convert the one or more images based on the image size information.

12. A computer readable medium according to claim 9, wherein the cellular telephone includes a digital camera with which the images attached in the e-mail are formed.

13. A computer readable medium according to claim 9, wherein the kiosk includes a personal computer connected to the server via a network connection.

14. A computer readable medium according to claim 13, wherein the kiosk includes a display through which the images sent to the kiosk can be viewed.

15. A computer readable medium according to claim 9, further configured to send a message to the cellular telephone including the identification number.

16. A computer readable medium according to claim 9, wherein the message sent to the cellular telephone includes an acknowledgment that the e-mail has been received.

17. A computer system for storing images, comprising:
a processor; and
a memory, coupled to the processor, the memory comprising a plurality of instructions executed by the processor, the plurality of instructions configured to:
receive an e-mail with one or more attached images from a cellular telephone;
generate an identification number corresponding to the received one or more images;
store the received one or more images in a memory;
receive a message from a kiosk including the identification number; and
send the one or more images to the kiosk based on the received identification number.

18. A computer system according to claim 17, the memory further comprising an instruction configured to receive image size information from the kiosk.

19. A computer system according to claim 18, the memory further comprising an instruction configured to convert the one or more images based on the image size information.

20. A computer system according to claim 17, wherein the cellular telephone includes a digital camera with which the images attached in the e-mail are formed.

21. A computer system according to claim 17, wherein the kiosk includes a personal computer connected to the server via a network connection.

22. A computer system according to claim 21, wherein the kiosk includes a display through which the images sent to the kiosk can be viewed.

23. A computer system according to claim 17, the memory further comprising an instruction configured to send a message to the cellular telephone including the identification number.

24. A computer system according to claim 17, wherein the message sent to the cellular telephone includes an acknowledgment that the e-mail has been received.
